(19) United States
(12) Patent Application Publication
(10) Pub. No.: US 2011/0006976 A1
(43) Pub. Date: Jan. 13, 2011

(54) FIELD SEQUENTIAL LIQUID CRYSTAL DISPLAY WITH PASSIVE MATRIX AND DRIVING METHOD THEREOF

(76) Inventors: Tung-Tsai Liao, Hsin Chu City (TW); Ying-Zhou Chen, Hsin-Chu City (TW); Heng-Chang Wu, Yun-Lin County (TW)

Correspondence Address: Muncy, Geissler, Olds & Lowe, PLLC, 4000 Legato Road, Suite 310, FAIRFAX, VA, 22033, US

(21) Appl. No.: 12/761,088

(22) Filed: Apr. 15, 2010

(30) Foreign Application Priority Data
Jul. 10, 2009 (TW) 098123303

(51) Int. Cl. G09G 3/36

(52) U.S. Cl. 345/102

(57) ABSTRACT

The present invention relates to a field sequential liquid crystal display (LCD) and driving method thereof. The method includes: turning the backlight off; step (a) of setting voltage of the segment signal lines to a first voltage and setting voltage of common signal lines to a second voltage level for a preset period so that the voltage of the pixels in LCD is set as fully white voltage; sequentially setting voltage of the common signal lines to a display common voltage in corresponding driving period, wherein when the voltage of the common signal lines is set to the display common voltage, a corresponding display data is outputted to the corresponding segment signal line; after a predetermined period from the step (a), providing a specific color backlight corresponding the display data.

This application claims priority of No. 098123303 filed in Taiwan R.O.C. on 2009, Aug. 10 under 35 USC 119, the entire content of which is hereby incorporated by reference.

### BACKGROUND OF THE INVENTION

1. Field of Invention

The invention relates to the technology associated with a liquid crystal display, and more particularly to a driving method for field sequential liquid crystal display with passive matrix and a passive matrix liquid crystal display using the same.

2. Related Art

In 1897, K. F. Braun invents the Braun tube. In 1929, the Russia scientist of America company RCA Vladimir Kosma Zworykin invents the design of the scanning electron beam. And the color television is popular in 1954. Until 1990, almost a century pass, the major applications of display technology are still focus on Cathode Ray Tube (CRT). However, in the beginning of 1990, flat panel display starts to be commercialized and the development of display technology changes with each passing day. From the viewpoints of popularization and the capacity of manufacture, liquid crystal display (LCD) is definitely the mainstream of the flat panel display technology.

FIG. 1 is a conventional structure diagram of the Twisted Nematic (TN)/Super Twisted Nematic (STN) liquid crystal display panel. Referring to FIG. 1, the liquid crystal panel 100 includes a plurality of common signal lines COM_0˜COM_N and a plurality of segment signal lines SEG_0˜SEG_M. The crossover points of each of common signal lines COM_0˜COM_N and each of segment lines SEG_0˜SEG_M are the pixels of the panel. FIG. 2 is a conventional equivalent circuit diagram of the Twisted Nematic (TN)/Super Twisted Nematic (STN) liquid crystal display panel. Referring to FIG. 2, In comparison with the conventional Thin-Film Transistor liquid crystal display panel, the difference is that each crossover point of each of common signal line COM_0˜COM_N and each of segment line SEG_0˜SEG_M is equal to a capacitor C201. In other words, each of pixels do not comprise active component.

In the conventional Spatial Color Filter (SCF) liquid crystal display technology, a pixel is constructed of three sub-pixels. By controlling the electric field strength, the luminous intensity of passing the sub-pixel or the luminous energy of passing the sub-pixel can be decided. With the modulation of the primary color (red, green, and blue) filter according to each sub-pixel, the luminous intensity of each primary color needed by each sub-pixel can be obtained. Then the primary color of each sub-pixel is mixed to form the desired color according to the principle of visual system. However, the traditional spatial color filter liquid crystal display technology must use white backlight module such as Cold Cathode Fluorescent Lamp (CCFL) or white light emitting diode.

In the conventional technology of SCF liquid crystal display panel, two thirds of luminous energy on average is absorbed by the color filter. Moreover, with the absorption of light diffuser and liquid crystal panel, only five percent lumen could pass the liquid crystal display panel. It results in bad transmittance and color saturation is also relatively low. Therefore the field sequential liquid crystal display is developed.

In the field sequential liquid crystal display technology, the color filter is removed from the liquid crystal module, thus it is unnecessary to divide the pixel into sub-pixels. The color can be formed by switching three primary colors (RGB) of the backlight sources with respect to time and synchronously controlling the transmittance of liquid crystal pixel within each color sources display period to adjust the relative lumen of each primary color, so that the color can be developed by the integration of the photic stimulation according to the visual system. Because of the Full Width at Half Maximum (FWHM) spectrum property of the light emitted by light emitting diode, the color gamut can be effectively expanded. Generally speaking, the field sequential liquid crystal display technology has better performance in high color gamut then the color filter based liquid crystal display technology.

The field sequential liquid crystal display divides a picture frame into red, green, and blue sub-frames. Thus each picture frame must be finished within 5.56 ms if the refresh rate is 60 frame per second. However, the passive matrix liquid crystal display, such as the Twisted Nematic (TN)/Super Twisted Nematic (STN) liquid crystal display panel, has slow response time of liquid crystal, there are no methods for integrating the field sequential display method into the passive liquid crystal display panel.

In addition, the display period of each prime color is defined as the display time of color field according to the display principle of the field sequential driving method. The color frame is formed after the photic stimulation of three uninterrupted color field is projected into a person and processed by the visual system. In ideal case, the three color field photic stimulations of a picture are all projected onto the retina and each pixel is mapped to the same position. Then the color information of each pixel can be completed reproduced. If the three color field photic stimulations of a picture are not mapped to the same position but being detected by the visual system, the observer would see a color field malposition image, and this is so called color breakup (CBU).

### SUMMARY OF THE INVENTION

An object of the invention is to provide a driving method of liquid crystal display applied to a passive matrix liquid crystal display for reducing the pixel response time of the passive matrix liquid crystal display so as to implement the field sequential display method on the passive matrix liquid crystal display.

Another object of the invention is to provide a passive matrix liquid crystal display for reducing the Color Breakup (CBU) on the field sequential liquid crystal display with passive matrix.

To achieve the above-identified or other objects, the invention provides a driving method of liquid crystal display applied to a passive matrix liquid crystal display, the passive matrix liquid crystal display comprises a backlight source, a plurality of segment signal lines and at least a common signal line, wherein the backlight source comprises a plurality of color backlight sources, the method comprises: (a) turning the backlight sources off; (b) setting voltage of the segment signal lines to a first voltage level and setting voltage of common signal lines to a second voltage level for a preset period so that the voltage of the pixels in LCD is set as full perviousness voltage; (c) sequentially setting voltage of the common signal lines to a display common voltage in a corresponding driving period, wherein when the voltage of the common signal lines is set to the display common voltage, a corresponding display data is outputted to the corresponding segment signal line; (d) after a predetermined period from the step (b), providing a specific color backlight corresponding to the display data, wherein, the specific color backlight is provided by one of the color backlight sources; and (e) backing to step (a) as step (c) is accomplished.

In addition, the invention provides a passive matrix liquid crystal display (LCD) comprising a passive matrix liquid crystal display panel, comprising a plurality of segment signal lines and at least a common signal line, a backlight source comprising a plurality of color backlight sources and a driving circuit coupled to the segment signal lines, the common voltage lines, and the backlight source. wherein the driving circuit repeats the steps below when the the passive matrix LCD is driven by the driving circuit: (a) turning the backlight source off; (b) setting voltage of the segment signal lines to a first voltage level and setting voltage of common signal lines to a second voltage level for a preset period so that the voltage of the pixels in LCD is set as full perviousness voltage; (c) sequentially setting voltage of the common signal lines to a display common voltage in a corresponding driving period, wherein when the voltage of the common signal lines is set to the display common voltage, a corresponding display data is outputted to the corresponding segment signal line; (d) after a predetermined period from the step (b), providing a specific color backlight corresponding the display data, wherein, the specific color backlight is provided by one of those color backlight sources.

According to the preferred embodiment of the driving method of the passive matrix liquid crystal display and the passive matrix liquid crystal using the same, the color backlight source comprise a red backlight source, a green backlight source, and a blue backlight source. Moreover, in a specific embodiment, the first voltage level is equal to the second voltage level when the passive matrix liquid crystal display is in a normal white screen mode; when the passive matrix liquid crystal display is in a normal black screen mode, the first voltage level is a ground voltage level and the second voltage level is a highest driving voltage level. In another embodiment, the first voltage level is a highest driving voltage level and the second voltage level is a ground voltage level when the passive matrix liquid crystal display is in a normal black screen mode.

The spirit of the invention is to set specific voltage levels to the segment signal lines and the common signal lines so that the voltage of the pixels in LCD is set as full perviousness voltage before the liquid crystal display is driven. In addition, the backlight source is turned off for a predetermined period before the liquid crystal display is driven. Therefore, It can speed up the pixel response of the passive matrix liquid crystal display as well as reduce the Color Breakup on the field sequential liquid crystal display with passive matrix.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention.

FIG. 1 is a conventional structure diagram of the Twisted Nematic (TN)/Super Twisted Nematic (STN) liquid crystal display panel.

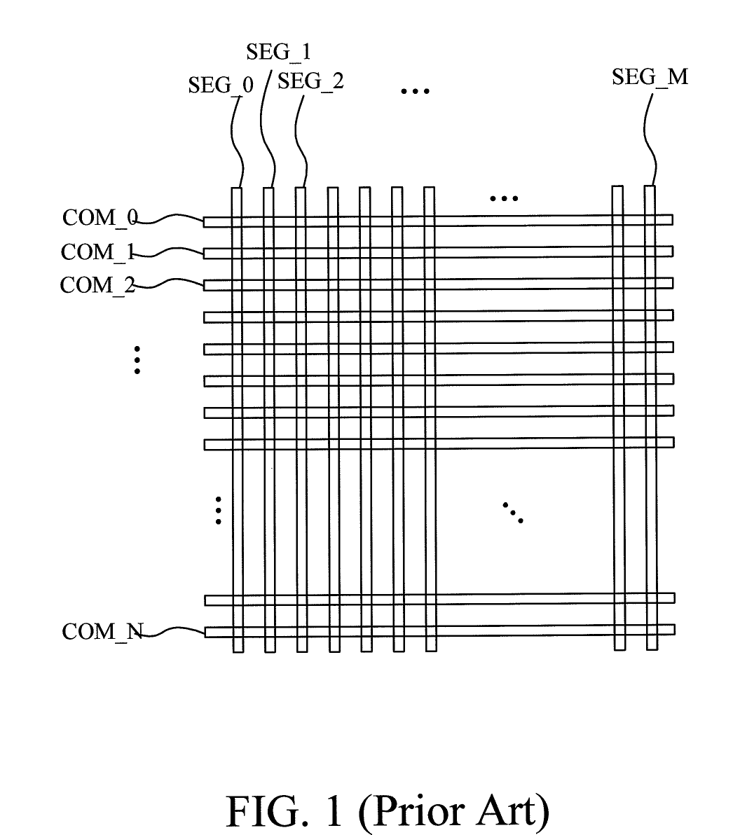

FIG. 2 is a conventional equivalent circuit diagram of the Twisted Nematic (TN)/Super Twisted Nematic (STN) liquid crystal display panel.

FIG. 3 is a circuit block diagram of a passive matrix liquid crystal display according to the embodiment of the invention.

FIG. 4 is the driving waveform of a passive matrix liquid crystal display according to the embodiment of the invention.

FIG. 5 is the flow chart of the driving method of a passive matrix liquid crystal display according to the embodiment of the invention.

FIG. 6 is the driving waveform of a passive matrix liquid crystal display according to the embodiment of the invention.

### DETAILED DESCRIPTION OF THE INVENTION

The present invention will be apparent from the following detailed description, which proceeds with reference to the accompanying drawings, wherein the same references relate to the same elements.

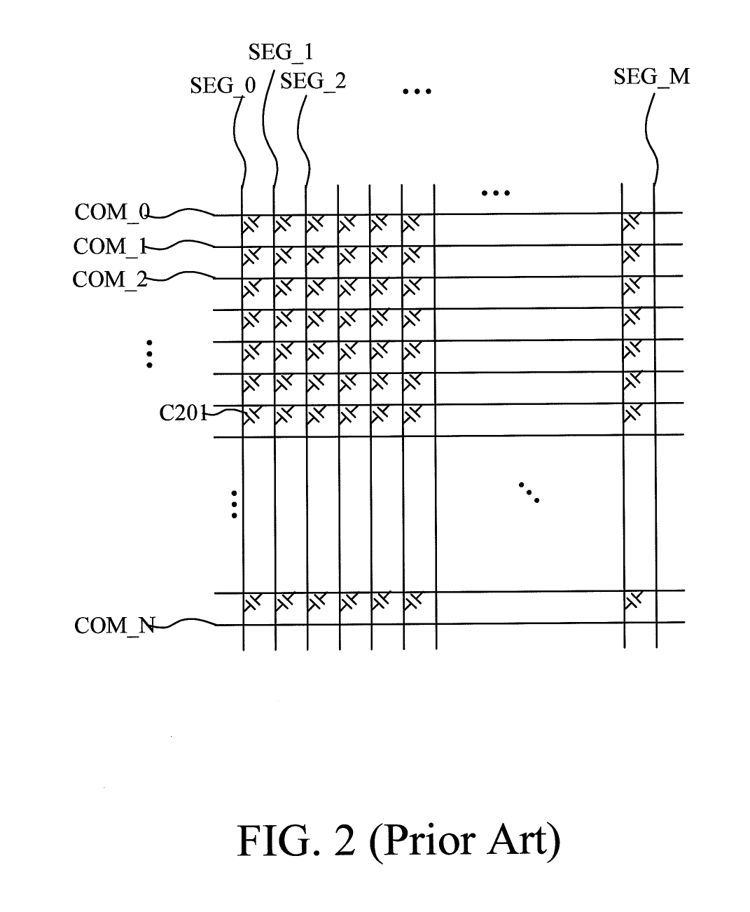

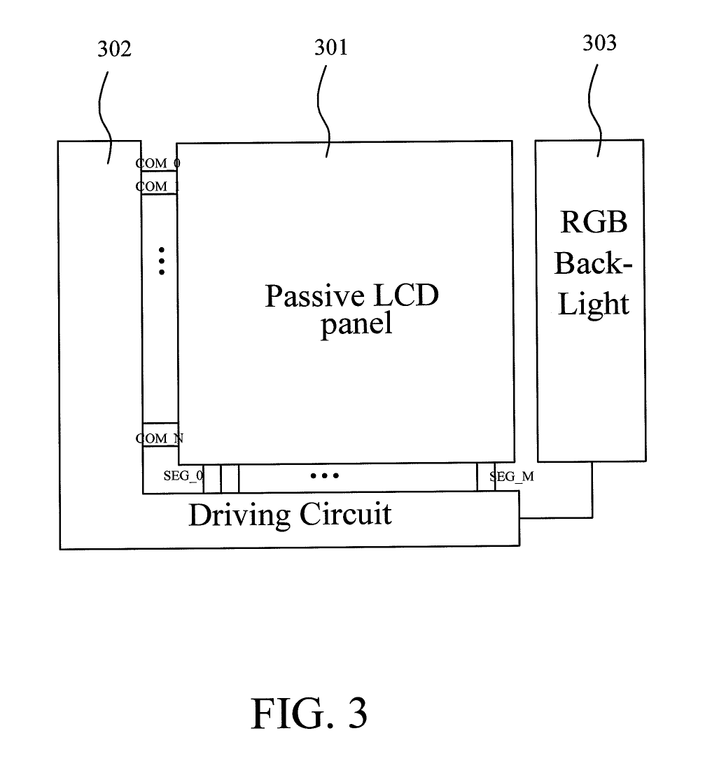

FIG. 3 is a circuit block diagram of a passive matrix liquid crystal display according to the embodiment of the invention. Referring to FIG. 2, the passive matrix liquid crystal display includes a passive matrix liquid crystal display panel 301, a driving circuit 302, and a backlight source 303, wherein the backlight source 303 includes R, G, B three primary color backlight sources.

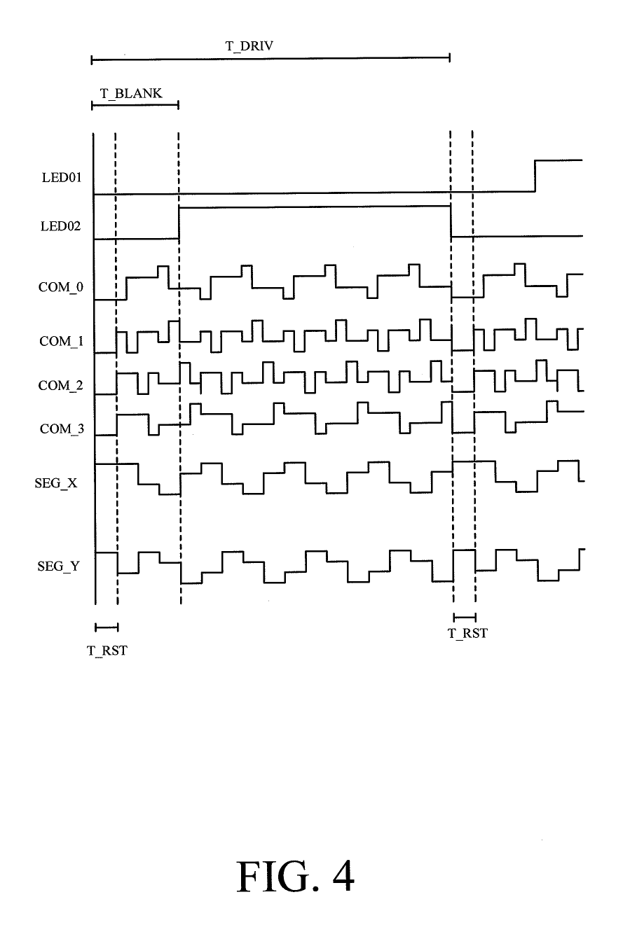

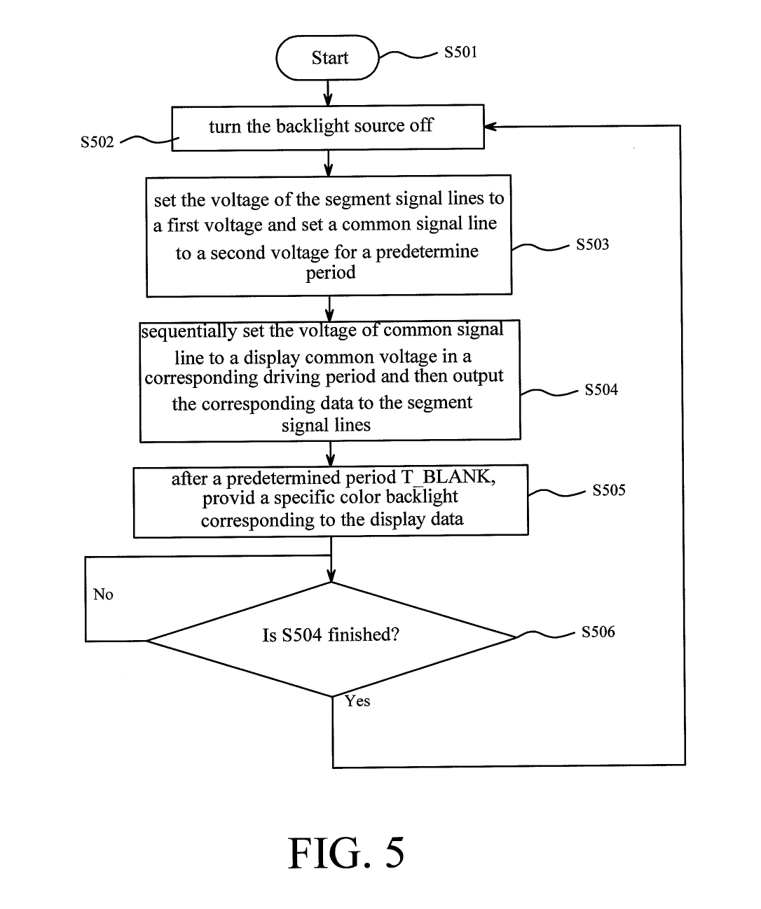

FIG. 4 is the driving waveform of a passive matrix liquid crystal display according to the embodiment of the invention. FIG. 5 is the flow chart of the driving method of a passive matrix liquid crystal display according to the embodiment of the invention. Referring to FIG. 4 and FIG. 5. To be simplified, there are only common signal lines COM_0˜COM_3 depicted in FIG. 4; SEG_X and SEG_Y are used to represent the whole segment signal lines SEG_0˜SEG_M. The following method is performed by the driving circuit 302. The method includes the following steps:

In step S501: the method starts.

In step S502: the backlight source is turned off by the driving circuit 302. Referring to FIG. 4, the backlight source is turn off within the period T_BLANK.

In step S503: the voltage of the segment signal lines is set to a first voltage level and the voltage of the common signal lines is set to a second voltage level. In this embodiment, supposed the panel type of the passive matrix liquid crystal display is a normal black LCD. During T_RST period, the driving circuit 302 outputs the highest driving voltage to the coupled segment signal lines SEG_0˜SEG_M, and outputs the ground voltage to the coupled common signal lines COM_0˜COM_N. Thus, the pixels of the passive matrix liquid crystal display panel would be set as full perviousness voltage because of the voltage difference.

In step S504: the voltage of the common signal lines COM_0˜COM_N is sequentially set to a display common voltage in a corresponding driving period, wherein when the voltage of the common signal lines is set to the display common voltage, a corresponding display data is outputted to the corresponding segment signal line SEG_1˜SEG_M. The detailed driving waveforms are depicted in FIG. 4 and the driving method belongs to prior art, thus detailed description is omitted.

In step S505: after a predetermined period T_BLANK from the step S503, providing a specific color backlight source corresponding to the display data. For example, if the display data is corresponding to red color backlight, the red color light emitting diode LED02 is lightened up.

In step S506: determine whether or not the step S504 is finished. If it is finished, changing to next color and back to step S502.

In the step S503, the pixels are set as full perviousness voltage before they are driven, thus it not only speeds up the pixel response of the passive matrix liquid crystal display panel 301 but also avoids the occurrence of afterimage. Therefore, the next picture frame would have the afterimage of the former picture frame without the step S503. For example, the green picture frame would have the afterimage of former red picture frame. Besides, the start of backlight source is delayed for the period of T_BLANK; it would greatly reduce the occurrence of Color Breakup.

Furthermore, although in FIG. 4, the first voltage level of the embodiment is ground voltage level and the second voltage level is the highest driving voltage level, a person having ordinary skill in the art should know that the voltage difference is used to set the pixel to full perviousness. Thus it gives same results while the first voltage level is the highest driving voltage and the second voltage is the ground voltage level. It is to be understood that the invention is not limited thereto. In addition, although the abovementioned embodiment uses the passive liquid crystal display panel 301 with a plurality of common signal lines COM_1˜COM_N to be an example, a person having ordinary skill in the art should know the invention could also be used in the passive liquid crystal display panel with one common signal line, it is to be understood that the invention is not limited thereto.

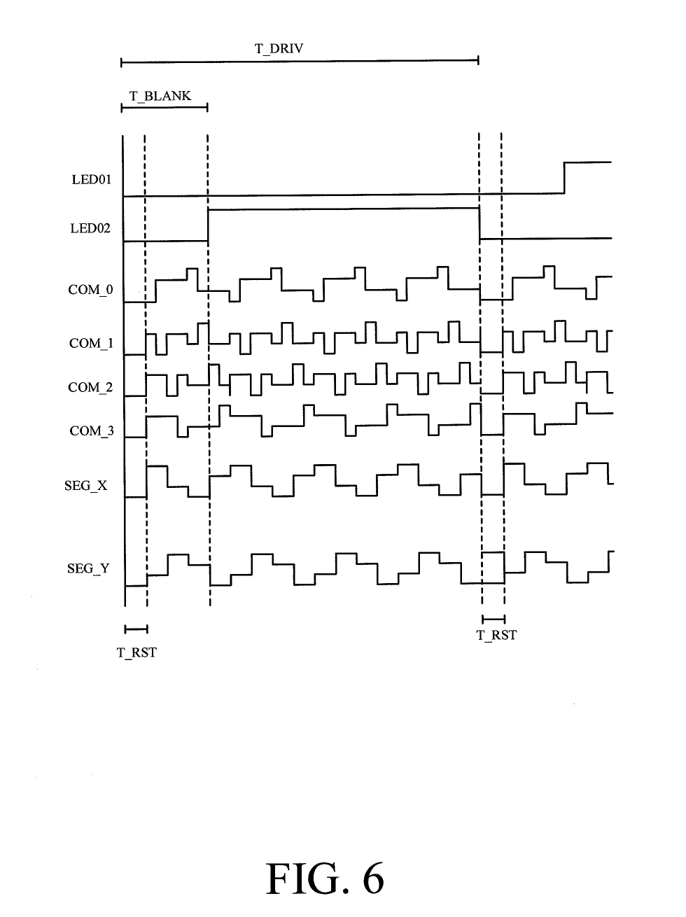

FIG. 6 is the driving waveform of a passive matrix liquid crystal display according to the embodiment of the invention. Referring to FIG. 6, similar to the driving waveform of FIG. 4, the display panel of FIG. 6 adopts a normal white passive matrix liquid crystal display panel. Thus, the first voltage level of the step S503 must be equal to the second voltage level in this embodiment. The difference between the embodiment of FIG. 4 and the embodiment of FIG. 6 is only the types of panel, it will result in different driving waveforms of the segment signal lines SEG_1˜SEG_M within T_RST. Since the spirit of the two embodiments is the same, the detailed description is omitted.

In summary, the spirit of the invention is to set specific voltage levels to the segment signal lines and the common signal lines so that the voltage of the pixels in LCD is set as full perviousness voltage before the liquid crystal display is driven. In addition, the backlight source is turned off for a predetermined period before the liquid crystal display is driven. Therefore, It can speed up the pixel response of the passive matrix liquid crystal display as well as reduce the Color Breakup on the field sequential liquid crystal display with passive matrix.

While the invention has been described by way of examples and in terms of preferred embodiments, it is to be understood that the invention is not limited thereto. To the contrary, it is intended to cover various modifications. Therefore, the scope of the appended claims should be accorded the broadest interpretation so as to encompass all such modifications.

What is claimed is:

1. A driving method of liquid crystal display applied to a passive matrix liquid crystal display, the passive matrix liquid crystal display comprises a backlight source, a plurality of segment signal lines and at least a common signal line, wherein the backlight source comprises a plurality of color backlight sources, wherein the method comprises:
(a) turning the backlight off;
(b) setting voltage of those segment signal lines to a first voltage level and setting voltage of common signal lines to a second voltage level for a preset period so that the voltage of the pixels in LCD is set as full perviousness voltage;
(c) sequentially setting voltage of the common signal lines to a display common voltage in a corresponding driving period, wherein when the voltage of the common signal lines is set to the display common voltage, a corresponding display data is outputted to the corresponding segment signal line;
(d) after a predetermined period from the step (b), providing a specific color backlight corresponding to the display data, wherein, the specific color backlight is provided by one of those color backlight sources; and
(e) back to step (a) as step (c) is accomplished.

2. The driving method of liquid crystal display according to claim 1, wherein the color backlight sources comprise a red backlight source, a green backlight source, and a blue backlight source.

3. The driving method of liquid crystal display according to claim 1, wherein the first voltage level is equal to the second voltage level when the passive matrix liquid crystal display is in a normal white LCD.

4. The driving method of liquid crystal display according to claim 1, wherein the first voltage level is a ground voltage level and the second voltage level is a highest driving voltage level when the liquid crystal display with passive matrix is in a normal black LCD.

5. The driving method of liquid crystal display according to claim 1, wherein the first voltage level is a highest driving voltage level and the second voltage level is a ground voltage level when the passive matrix liquid crystal display is in a normal black LCD.

6. A passive matrix liquid crystal display, comprising:
a passive matrix liquid crystal display panel, comprising a plurality of segment signal lines and at least a common signal line;
a backlight source, comprising a plurality of color backlight sources; and
a driving circuit coupled to the segment signal lines, the common voltage lines, and the backlight source,
wherein the driving circuit repeats the steps as below when the passive matrix liquid crystal display is driven:
(a) turning the backlight off;
(b) setting voltage of those segment signal lines to a first voltage level and setting voltage of common signal lines to a second voltage level for a preset period so that the voltage of the pixels in LCD is set as full perviousness voltage;
(c) sequentially setting voltage of the common signal lines to a display common voltage in a corresponding driving period, wherein when the voltage of the common signal lines is set to the display common voltage, a corresponding display data is outputted to the corresponding segment signal line;
(d) after a predetermined period from the step (b), providing a specific color backlight corresponding to the display data, wherein, the specific color backlight is provided by one of those color backlight sources.

7. The passive matrix liquid crystal display according to claim 6, wherein those color backlight sources comprise a red backlight source, a green backlight source, and a blue backlight source.

8. The passive matrix liquid crystal display according to claim 6, wherein the first voltage level is equal to the second voltage level when the passive matrix liquid crystal display is a normal white LCD.

9. The passive matrix liquid crystal display according to claim 6, wherein the first voltage level is a ground voltage level and the second voltage level is a highest driving voltage level when the passive matrix liquid crystal is a normal black LCD.

10. The passive matrix liquid crystal display according to claim 6, wherein the first voltage level is a highest driving voltage level and the second voltage level is a ground voltage level when the passive matrix liquid crystal display is a normal black LCD.
